(19) United States
(12) Patent Application Publication
(10) Pub. No.: US 2019/0093680 A1
(43) Pub. Date: Mar. 28, 2019

(54) HYDRAULIC CONTROL DEVICE FOR VEHICLE DRIVE DEVICE

(71) Applicant: AISIN AW CO., LTD., Anjo-shi, Aichi-ken (JP)

(72) Inventors: Eikichi KIDOKORO, Anjo (JP); Kaname MATSUYAMA, Anjo (JP)

(73) Assignee: AISIN AW CO., LTD., Anjo-shi, Aichi-ken (JP)

(21) Appl. No.: 16/086,841

(22) PCT Filed: Apr. 20, 2017
(86) PCT No.: PCT/JP2017/015930

§ 371 Date: Sep. 20, 2018

(30) Foreign Application Priority Data
Apr. 20, 2016 (JP) 2016-084720
Sep. 30, 2016 (JP) 2016-194855
Feb. 27, 2017 (JP) 2017-035251

(51) Int. Cl. F15B 13/08; F16H 61/00; F15B 21/00; F16K 11/085

(52) U.S. Cl. CPC F15B 13/0839; F16H 61/0009; F16K 11/085; F15B 21/001; F15B 21/005; F15B 13/0871

(57) ABSTRACT

A hydraulic control device for a vehicle drive device that includes a first layer having a first opposing surface, a first groove formed in the first opposing surface, and a first bonding formed on the first opposing surface and surrounding the first groove; and a second layer having a second opposing surface facing the first opposing surface, a second groove facing the first groove and formed in the second opposing surface, and a second bonding facing the first bonding, surrounding the second groove, and bonded to the first bonding, the second opposing surface being placed on, and bonded to, the first opposing surface, so that the first groove and the second groove form a first oil passage.

### BACKGROUND

The present disclosure relates to hydraulic control devices for vehicle drive devices that are mounted on, e.g., vehicles.

Conventionally, hydraulic control devices for vehicle drive devices which include a valve body having various valves such as a plurality of linear solenoid valves, switch valves, etc. (hereinafter simply referred to as the valves) and oil passages that allow the valves to communicate with each other have been widely used in the art. Valve bodies are typically made of a metal such as aluminum die cast. In recent years, however, valve bodies that are produced by stacking several synthetic resin blocks each having oil passage halves formed by injection molding and joining the stacked blocks into a single piece by welding etc. have been developed (see Japanese Patent Application Publication No. 2012-82917).

In this valve body, a plate-like heating element is interposed between the stacked blocks, and the contact surfaces between the plate-like heating element and the blocks are melted by microwave radiation so that the blocks are bonded together by welding. The opposing surfaces that face each other as a result of stacking the blocks closely stick together, and the oil passage halves formed in each of the opposing surfaces are combined to form oil passages.

### SUMMARY

However, the configuration of a seal that restrains oil leakage from the oil passages thus formed has not been considered in the aforementioned valve body. One possible way to prevent oil leakage from such oil passages when high pressure hydraulic oil such as a line pressure or a range pressure flows therein is to interpose a sealing material such as a gasket between the opposing surfaces of the blocks to be stacked. In this case, in addition to bonding portions where the plate-like heating element is interposed between the opposing surfaces for welding, sealing portions need to be provided on the same plane so that molten resin will not enter the oil passages to form unwanted portions. This increases the size of the valve body.

An exemplary aspect of the disclosure provides a hydraulic control device for a vehicle drive device which restrains an increase in size of a valve body while providing sealability required for oil passages.

A hydraulic control device for a vehicle drive device according to the present disclosure includes: a first layer having a first opposing surface, a first groove formed in the first opposing surface, and a first bonding formed on the first opposing surface and surrounding the first groove; and a second layer having a second opposing surface facing the first opposing surface, a second groove facing the first groove and formed in the second opposing surface, and a second bonding facing the first bonding, surrounding the second groove, and bonded to the first bonding, the second opposing surface being placed on, and bonded to, the first opposing surface, so that the first groove and the second groove form a first oil passage, wherein the first bonding is a protrusion protruding toward the second bonding, the second bonding is a recess having the protrusion fitted therein, and the first bonding and the second bonding are bonded together to surround and seal the first oil passage located in both the first opposing surface and the second opposing surface.

According to the hydraulic control device for the vehicle drive device, the first bonding, which is a protrusion, and the second bonding, which is a recess, are fitted and bonded together to surround and seal the first oil passage located in both the first opposing surface and the second opposing surface. In this case, the first bonding and the second bonding which serve to bond the first layer and the second layer together also serve to seal the first oil passage. Accordingly, an increase in size of a valve body is restrained while providing sealability required for oil passages, as compared to the case where bonding portions and sealing portions are bonded together by flat surface portions.

### BRIEF DESCRIPTION OF THE DRAWINGS

FIG. 1 is a schematic diagram of a vehicle having mounted thereon a hydraulic control device for a vehicle drive device according to a first embodiment.

FIG. 2 is a perspective view of the hydraulic control device according to the first embodiment.

FIG. 3 is an exploded perspective view of the hydraulic control device according to the first embodiment.

FIG. 4 is a plan view showing a fourth surface of a third block of a valve body of the hydraulic control device according to the first embodiment.

FIG. 5 is a plan view showing a sixth surface of a fifth block of the valve body of the hydraulic control device according to the first embodiment.

FIG. 6 is a plan view showing a seventh surface of a sixth block of the valve body of the hydraulic control device according to the first embodiment.

FIG. 7 is a sectional view of the hydraulic control device according to the first embodiment.

FIG. 8A is a sectional view showing an oil passage and bonding portions of the hydraulic control device according to the first embodiment in which the bonding portions have not been fitted together.

FIG. 8B is a sectional view showing the oil passage and the bonding portions of the hydraulic control device according to the first embodiment in which the bonding portions have been fitted together.

FIG. 9 is a sectional view of the hydraulic control device according to the first embodiment taken along line A-A in FIGS. 4 and 5.

FIG. 10 is a sectional view of a hydraulic control device according to a second embodiment.

### DETAILED DESCRIPTION OF EMBODIMENTS

### First Embodiment

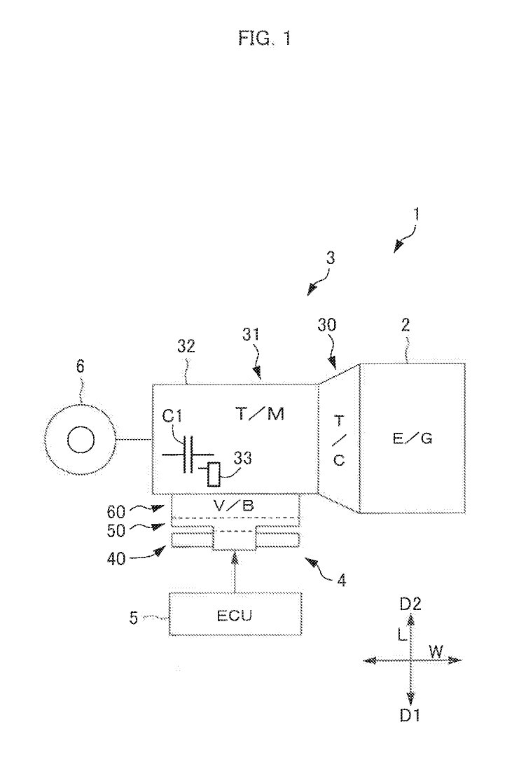

A first embodiment of a hydraulic control device for a vehicle drive device will be described below with reference to FIGS. 1 to 9. First, the general configuration of a vehicle 1 on which an automatic transmission 3 as an example of the vehicle drive device is mounted will be described with reference to FIG. 1. As shown in FIG. 1, the vehicle 1 of the present embodiment includes, e.g., an internal combustion engine 2, an automatic transmission 3, a hydraulic control device 4 and an ECU (control device) 5 which control the automatic transmission 3, and wheels 6. The internal combustion engine 2 is an internal combustion engine such as, e.g., a gasoline engine or a diesel engine, and is coupled to the automatic transmission 3. In the present embodiment, the automatic transmission 3 is of what is called a front-engine, rear-drive (FR) type. However, the automatic transmission 3 is not limited to the FR type and may be of a front-engine, front-drive (FF) type. The same hydraulic control device 4 may be used for both the FR type automatic transmission 3 and an FF type automatic transmission. In the present embodiment, a vehicle using only an internal combustion engine as a driving source is described as an example of a vehicle to which the vehicle drive device is applied. However, the present disclosure is not limited to this. The present disclosure may be applied to, e.g., a hybrid vehicle using an internal combustion engine and an electric motor as driving sources.

The automatic transmission 3 has a torque converter 30, a speed change mechanism 31, and a transmission case 32 accommodating these components. The torque converter 30 is interposed between the internal combustion engine 2 and the speed change mechanism 31 and can transmit a driving force of the internal combustion engine 2 to the speed change mechanism 31 via hydraulic fluid. The torque converter 30 has a lockup clutch, not shown, and can directly transmit a driving force of the internal combustion engine 2 to the speed change mechanism 31 by engagement of the lockup clutch.

The speed change mechanism 31 is a multi-speed speed change mechanism that can establish a plurality of shift speeds by engagement and disengagement of a plurality of clutches and brakes including a first clutch (friction engagement element) C1. The speed change mechanism 31 has a hydraulic servo 33 that can engage and disengage the first clutch C1 by supplying and cutting off supply of an oil pressure. However, the speed change mechanism 31 is not limited to the multi-speed transmission, and may be a continuously variable speed change mechanism such as a belt-type continuously variable automatic speed change mechanism.

The hydraulic control device 4 is formed by, e.g., a valve body. The hydraulic control device 4 can generate a line pressure, a modulator pressure, etc. from oil pressures supplied from an oil pump, not shown, and can supply and cut off supply of oil pressures that control the clutches and the brakes of the speed change mechanism 31 based on control signals from the ECU 5. The configuration of the hydraulic control device 4 will be described in detail below.

The ECU 5 includes, e.g., a CPU, a ROM that stores processing programs, a RAM that temporarily stores data, input and output ports, and a communication port and outputs various signals, such as control signals for the hydraulic control device 4, from the output port.

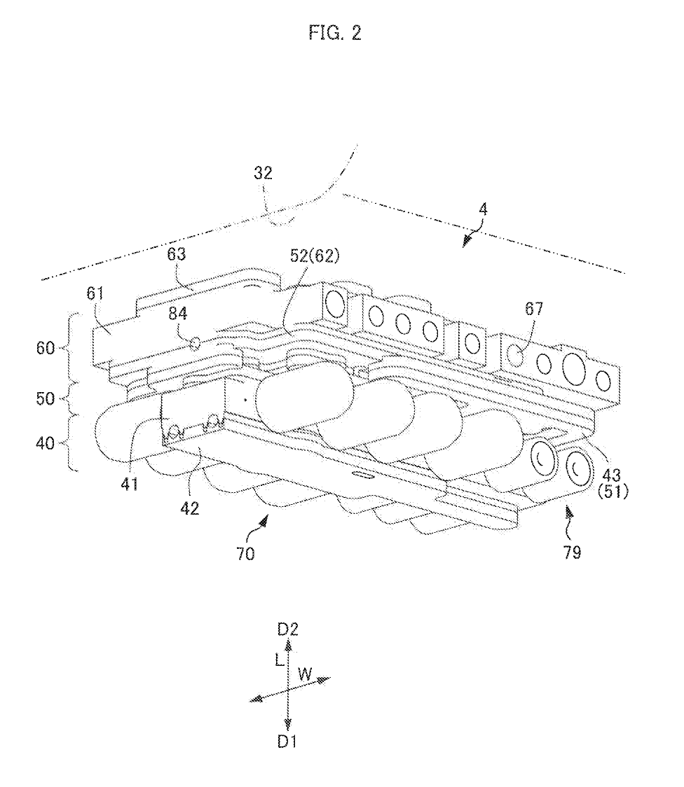

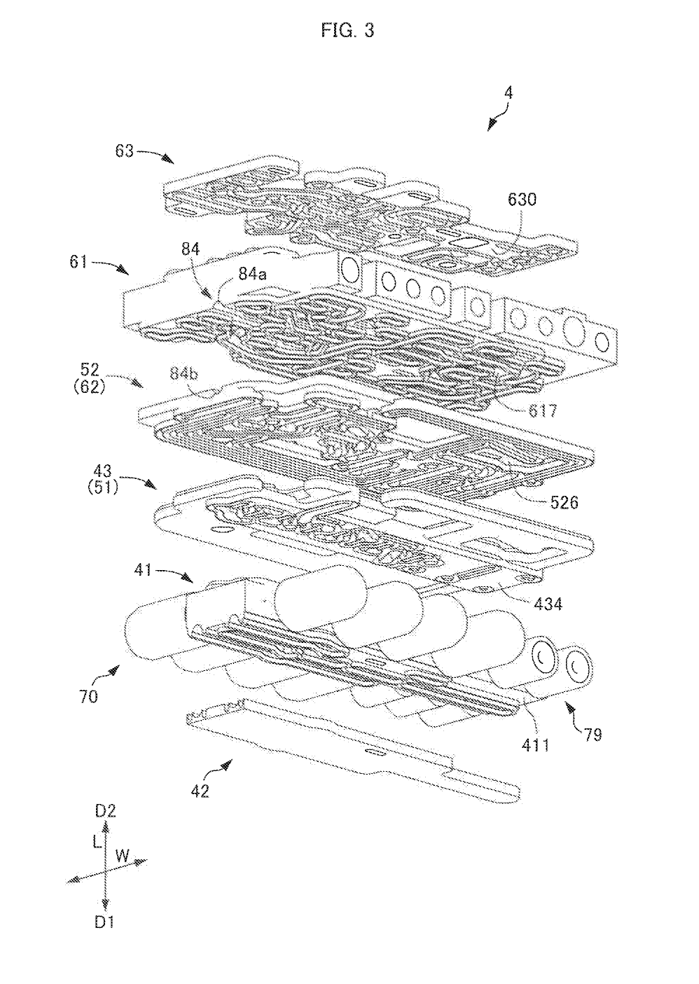

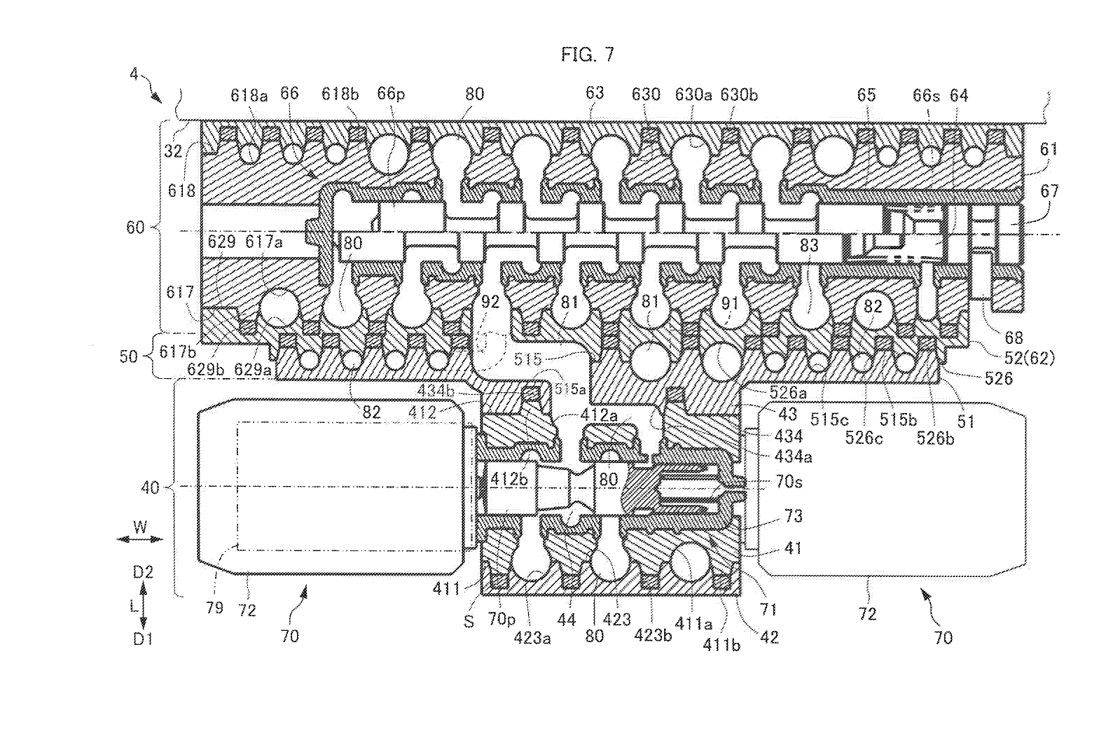

Next, the configuration of the aforementioned hydraulic control device 4 will be described in detail with reference to FIGS. 2 to 9. As shown in FIGS. 2 and 3, the hydraulic control device 4 is a valve body and is formed by stacking a solenoid mounting portion 40 accommodating pressure regulating portions 71 of linear solenoid valves 70, a valve mounting portion 60 accommodating valves such as switch valves 66 (see FIG. 7), and an oil passage mounting portion 50 interposed between the solenoid mounting portion 40 and the valve mounting portion 60. In the present embodiment, the stacking direction L is the vertical direction, and the valve mounting portion 60 is attached to the transmission case 32 with the solenoid mounting portion 40 facing downward (first direction D1) and the valve mounting portion 60 facing upward (second direction D2). That is, of the stacking direction L, the direction from the oil passage mounting portion 50 toward the solenoid mounting portion 40 is the first direction D1, and the opposite direction is the second direction D2.

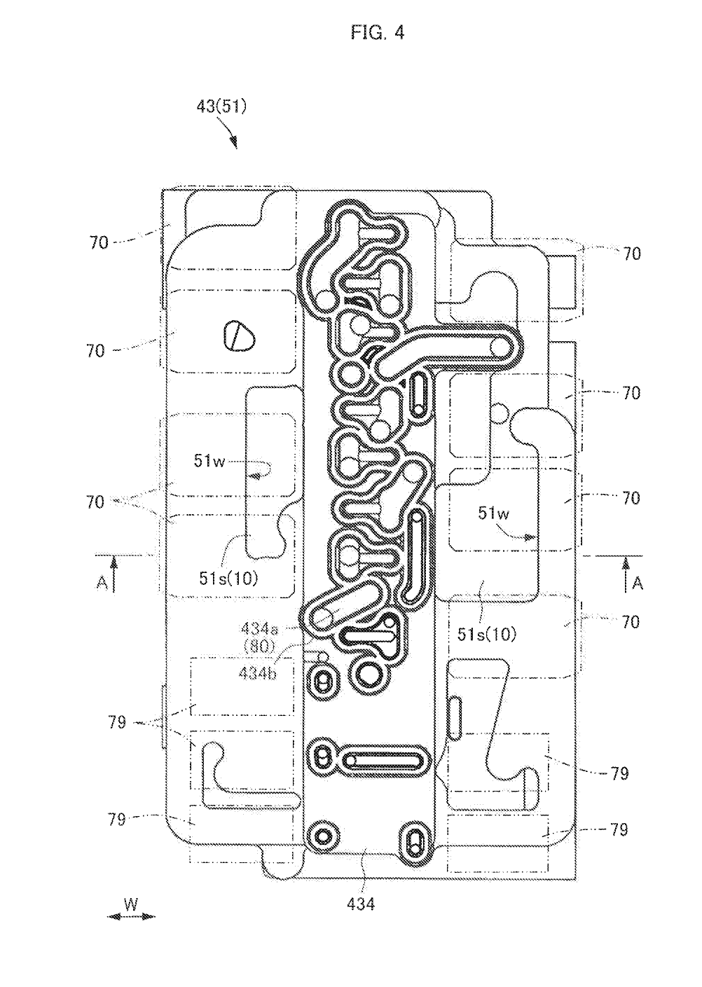

As shown in FIGS. 2, 3, 7, 8A and 8B, the solenoid mounting portion 40 has three substantially plate-like synthetic resin blocks, namely a first block 41, a second block 42, and a third block 43 (see FIG. 4), and is formed by stacking these three layers and joining the stacked layers by, e.g., injection molding.

The first block 41 is the middle one of the three layers forming the solenoid mounting portion 40 and has a plurality of holes 44 extending inward alternately from its one side end and the opposite other side end in a direction perpendicular to the stacking direction L. In the present embodiment, the first block 41 is formed with bottomed cylindrical metal sleeves 73 insert-molded therein by primary injection molding of a DSI method, and the insides of the sleeves 73 are the holes 44. In the present embodiment, the lateral direction W is the direction in which the holes 44 extend.

A linear solenoid valve 70 or a solenoid valve 79 is mounted in each sleeve 73. The linear solenoid valves 70 and the solenoid valves 79 are mounted with their central axes being parallel and on the same plane. The linear solenoid valve 70 has a pressure regulating portion 71 that is accommodated in the sleeve 73 and regulates an oil pressure by a spool 70p, and a solenoid portion 72 that drives the pressure regulating portion 71 according to an electrical signal. The pressure regulating portion 71 has the slidable spool 70p that regulates an oil pressure, and a biasing spring 70s, which is a compression coil spring that presses the spool 70p in one direction. Each sleeve 73 has ports, which are multiple through holes, in its peripheral side surface. Each port is formed along substantially the entire circumference and is closed, except for its opening portion, by the synthetic resin forming the first block 41. The linear solenoid valve 70 can supply an oil pressure to, e.g., the hydraulic servo 33 that can engage and disengage the first clutch C1, etc.

The first block 41 has a first surface 411 facing the first direction D1, a plurality of grooves 411a with a semicircular section, which are formed in the first surface 411, and a protrusion 411b formed on the first surface 411. The plurality of grooves 411a communicate with a part of the plurality of ports of the linear solenoid valves 70 or the solenoid valves 79. The protrusion 411b protrudes toward the second block 42. The first block 41 further has a second surface 412 facing the second direction D2, a plurality of grooves 412a with a semicircular section, which are formed in the second surface 412, and a protrusion 412b formed on the second surface 412. The plurality of grooves 412a communicate with a part of the plurality of ports of the linear solenoid valves 70 or the solenoid valves 79. The protrusion 412b protrudes toward the third block 43. The first block 41 further has the plurality of holes 44 formed between the first surface 411 and the second surface 412 so as to extend along the first surface 411 and the second surface 412 and accommodating the pressure regulating portions 71.

The second block 42 has a third surface 423 facing the first surface 411 of the first block 41, a plurality of grooves 423a with a semicircular section, which are formed in the third surface 423, and a recess 423b formed in the third surface 423. The plurality of grooves 423a are formed so as to face the plurality of grooves 411a. The second block 42 is stacked on the first block 41 with the third surface 423 facing the first surface 411 of the first block 41, so that the plurality of grooves 411a and the plurality of grooves 423a form a plurality of oil passages 80. The recess 423b is recessed in the same direction as that in which the protrusion 411b on the first surface 411 protrudes, and the protrusion 411b is fitted in the recess 423b with clearance in the stacking direction L. The first block 41 and the second block 42 are stacked such that the protrusion 411b is fitted in the recess 423b between adjacent ones of the oil passages 80, and are joined by injection molding using the clearance between the protrusion 411b and the recess 423b as a cavity.

The third block 43 is stacked on the opposite side of the first block 41 from the second block 42. The third block 43 has a fourth surface 434 facing the second surface 412 of the first block 41 a plurality of grooves 434a with a semicircular section, which are formed in the fourth surface 434, and a recess 434b formed in the fourth surface 434. The plurality of grooves 434a are formed so as to face the plurality of grooves 412a. The third block 43 is stacked on the first block 41 with the fourth surface 434 facing the second surface 412 of the first block 41, so that the plurality of grooves 412a and the plurality of grooves 434a form a plurality of oil passages 80. The recess 434b is recessed in the same direction as that in which the protrusion 412b on the second surface 412 protrudes, and the protrusion 412b is fitted in the recess 434b with clearance in the stacking direction L. The first block 41 and the third. block 43 are stacked such that the protrusion 412b is fitted in the recess 434b between adjacent ones of the oil passages 80, and are joined by injection molding using the clearance between the protrusion 412b and the recess 434b as a cavity.

The oil passages 80 formed by the first block 41 and the third block 43 communicate with the valve mounting portion 60 via the oil passage mounting portion 50 or allow the ports of the linear solenoid valves 70 or the ports of the solenoid valves 79 to communicate with each other. The oil passages 80 formed by the first block 41 and the second block 42 allow the ports of the linear solenoid valves 70 or the ports of the solenoid valves 79 to communicate with each other.

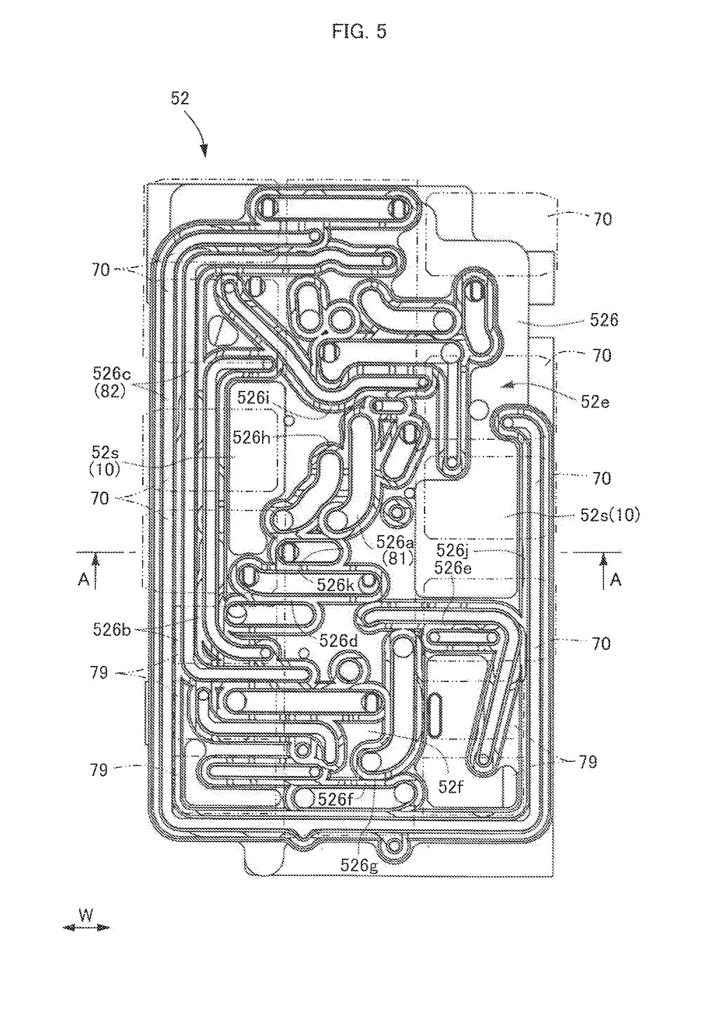

The oil passage mounting portion 50 has two substantially plate-like synthetic resin blocks, namely a fourth block 51 and a fifth block (first layer) 52 (see FIG. 5), and is formed by stacking these two layers and joining the stacked layers by, e.g., injection molding. In the present embodiment, the fourth block 51 is disposed on the side of the third block 43 which faces the second direction D2, and the fourth block 51 and the third block 43 are formed by a single member. However, the fourth block 51 and the third block 43 are not limited to a single member. The fourth block 51 and the third block 43 may be formed by separate members joined by injection molding, adhesion, welding, etc.

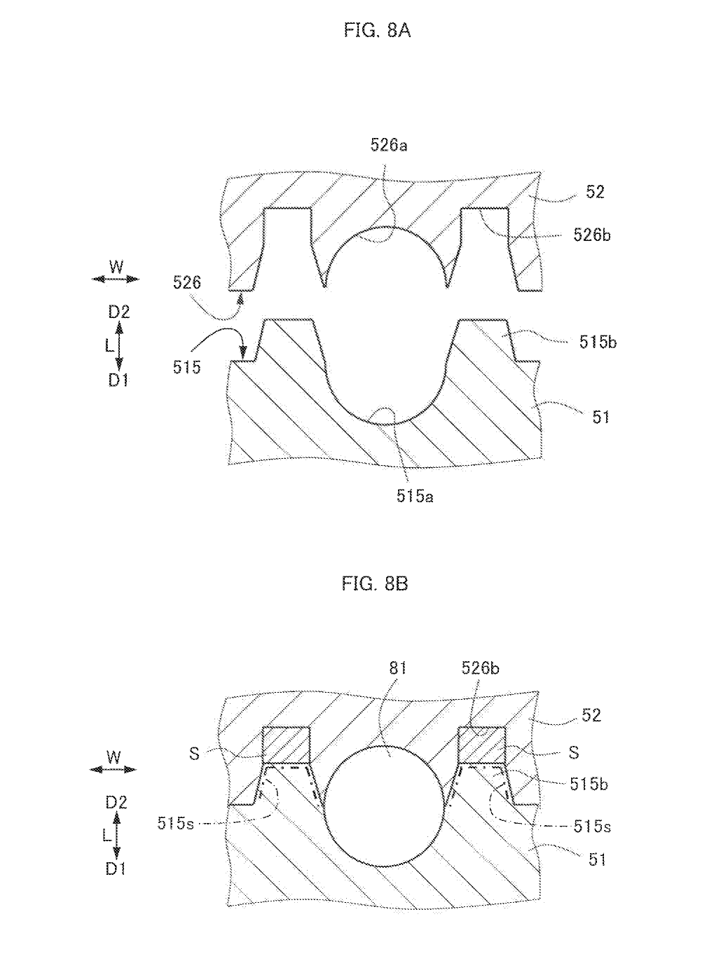

The fourth block 51 has a fifth surface (first opposing surface) 515 facing the second direction D2, a plurality of large diameter grooves 515a and a plurality of small diameter grooves 515c with a semicircular section, which are formed in the fifth surface 515, and a protrusion (first bonding portion/first bonding, third bonding portion/third bonding) 515b formed on the fifth surface 515 (see FIGS. 7 and 8A). The protrusion 515b protrudes in the second direction D2 and is formed on the fifth surface 515 so as to surround the plurality of grooves (first grooves, third grooves) 515a, 515c. The plurality of large diameter grooves 515a are disposed so as to overlap the pressure regulating portions 71 of the linear solenoid valves 70 as viewed in the stacking direction L. The plurality of small diameter grooves 515c are disposed so as to overlap the solenoid portions 72 of the linear solenoid valves 70 as viewed in the stacking direction L. That is, the fifth block 52 has the fifth surface 515, the plurality of grooves 515a, 515c formed in the fifth surface 515, and the protrusion 515b formed on the fifth surface 515 so as to surround the plurality of grooves 515a, 515c.

As shown in FIGS. 5, 8A and 8B, the fifth block 52 has a sixth surface (second opposing surface) 526 facing the fifth surface 515 of the fourth block 51, a plurality of large diameter grooves 526a and a plurality of small diameter grooves 526c with a semicircular section, which are formed in the sixth surface 526, and a recess (second bonding portion/second bonding, fourth bonding portion/fourth bonding) 526b formed in the sixth surface 526 (see FIG. 8A). The plurality of large diameter grooves 526a are formed so as to face the plurality of large diameter grooves 515a. The plurality of small diameter grooves 526c are formed so as to face the plurality of small diameter grooves 515c. The fifth block 52 is stacked on the fourth block 51 with the sixth surface 526 facing the fifth surface 515 of the fourth block 51, so that the plurality of large diameter grooves 526a and the plurality of large diameter grooves 515a form a plurality of large diameter oil passages (first oil passages, second oil passages) 81 (see FIG. 8B), and the plurality of small diameter grooves 526c and the plurality of small diameter grooves 515c form a plurality of small diameter oil passages (first oil passages, second oil passages) 82 (see FIG. 7). The recess 526b is recessed in the same direction as that in which the protrusion 515b on the fifth surface 515 protrudes, and the protrusion 515b is fitted in the recess 526b with clearance in the stacking direction L. That is, the recess 526b is formed in the sixth surface 526 so as to surround the plurality of grooves (second grooves, fourth grooves) 526a, 526c. The fourth block 51 and the fifth block 52 are stacked such that the protrusion 515b is fitted in the recess 526b between adjacent ones of the oil passages 81, 82, and are joined by injection molding using the clearance between the protrusion 515b and the recess 526b as a cavity.

That is, the fifth block 52 has the sixth surface 526 facing the fifth surface 515, the plurality of grooves 526a, 526c facing the plurality of grooves 515a, 515c, and the recess 526b facing, and bonded to, the protrusion 515b. The fifth block 52 is stacked on the fourth block 51 with the sixth surface 526 being in close contact with the fifth surface 515, whereby the plurality of grooves 515a, 515c and the plurality of grooves 526a, 526c form the oil passages 81, 82. The protrusion 515b and the recess 526b are bonded together, thereby surrounding and sealing the oil passages 81, 82 located in both the fifth surface 515 and the sixth surface 526.

The large diameter oil passages 81 communicate with a large diameter communication oil passage (communication oil passage) 91 formed in at least one of the fourth block 51 and the fifth block 52. The large diameter communication oil passage 91 communicates with, e.g., the large diameter oil passages 80 formed between the second surface 412 and the fourth surface 434, large diameter oil passages 80 formed between a seventh surface 617 and a ninth surface 629, etc. The small diameter oil passages 82 communicate with a small diameter communication oil passage (communication oil passage) 92 formed in at least one of the fourth block 51 and the fifth block 52. The small diameter communication oil passage 92 communicates with, e.g., small diameter oil passages formed between the second surface 412 and the fourth surface 434, small diameter oil passages formed between the seventh surface 617 and the ninth surface 629, etc. The oil passages 81, 82 thus allow hydraulic oil to flow, e.g., between the fourth block 51 and the fifth block 52, from the fourth block 51 to the fourth block 51, or from the fifth block 52 to the fifth block 52. For example, the oil passages 81, 82 allow two of the hydraulic servo 33 for the first clutch C1, the linear solenoid valves 70, and input ports of the switch valves 66 to communicate with each other.

As shown in FIGS. 8A and 8B, the first bonding portion is the protrusion 515b protruding toward the second bonding portion, and the second bonding portion is the recess 526b recessed in the same direction as that in which the protrusion 515b protrudes and having the protrusion 515b fitted therein. The height of the protrusion 515b is smaller than the depth of the recess 526b. The space between the distal end face of the protrusion 515b and the bottom surface of the recess 526b is filled with a sealing member S, and the protrusion 515b and the recess 526b are bonded together by the sealing member S. Moreover, the sealing member S is an injection molding material and the protrusion 515b and the recess 526b are bonded together by injection molding. In this case, the sealing width between the protrusion 515b and the recess 526b is the total length of three surfaces, namely the side surfaces and the end face, of the protrusion 515b (the portions (515s) shown by alternate long and short dash lines in FIG. 8B). Accordingly, as compared to the case where the protrusion 515b and the recess 526b are not formed, the sealing width relative to the length in the lateral direction W of the blocks is increased, which improves sealability without increasing the size of the valve body. The sealing member S may be made of the same material as that of the blocks, or may be made of a material different from that of the blocks as long as the material can be bonded to the blocks.

In the present embodiment, as shown in FIG. 5, adjacent ones of the recesses 526b that are formed in the sixth surface 526 are formed as a single common recess (e.g., a recess 526d in FIG. 5) in a portion where two large diameter oil passages 81, 81 as a first oil passage and a second oil passage are located adjacent to each other. Similarly, adjacent ones of the recesses 526b that are formed in the sixth surface 526 are formed as a single common recess (e.g., a recess 526e in FIG. 5) in a portion where two small diameter oil passages 82, 82 as a first oil passage and a second oil passage are located adjacent to each other. In each of such portions, adjacent ones of the protrusions 515b that are formed in the fifth surface 515 are also formed as a single common protrusion. That is, for example, in a region where the interval between two large diameter oil passages 81, 81 is smaller than the sum of the width of a protrusion 515b and a recess 526b bonded together and the width of an adjacent protrusion 515b and an adjacent recess 526b bonded together, the protrusions 515b and the recesses 526b are formed as a single common protrusion and a single common recess bonded together. Since the protrusions 515b and the recesses 526b are thus formed as a single common protrusion and a single common recess in such a region, the number of places where the protrusion 515b and the recess 526b should be formed is minimized. This simplifies the structure of the valve body and achieves reduction in size of the valve body.

For example, the following configuration can be provided in a region where the interval between two large diameter oil passages 81, 81 is equal to or larger than the sum of the width of a protrusion 515b and a recess 526b bonded together and the width of an adjacent protrusion 515b and an adjacent recess 526b bonded together. For example, two pairs of protrusions 515b and recesses 526b can be disposed independently of and adjacent to each other (e.g., recesses 526f, 526g in FIG. 5). Moreover, for example, the solid fourth block 51 and the solid fifth block 52 can be disposed between two pairs of protrusions 515b and recesses 526b (e.g., recesses 526h, 526i in FIG. 5). In this case, other oil passages such as a drain oil passage may be provided between the two pairs of protrusions 515b and recesses 526b. That is, in this case, no space such as a void 10, which will be described below, is present between the two pairs of protrusions 515b and recesses 526b.

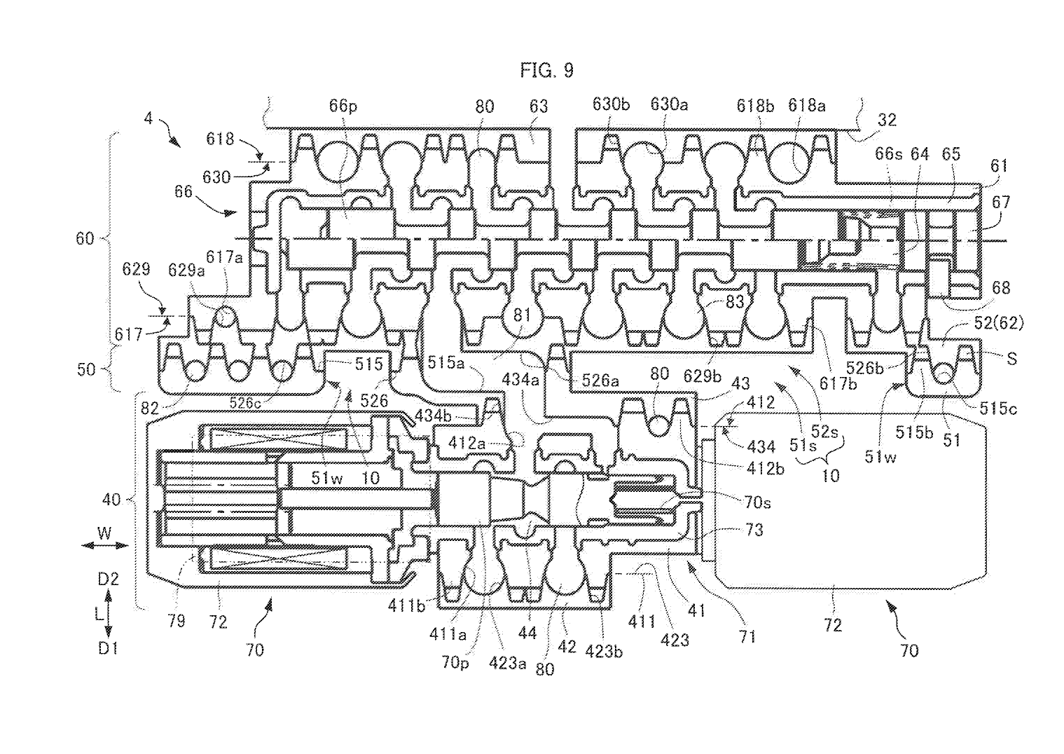

Moreover, for example, a void 10 can be created between two pairs of protrusions 515b and recesses 526b (e.g., recesses 526j, 526k in FIG. 5). As shown in FIG. 9, the void 10 is created in the sixth surface 526 so as to be surrounded by a wall surface 51w that is formed in the outer peripheral side surface of the fourth block 51 having, in at least a part of the fourth block 51, a communication portion 52e (communicator) (see FIG. 5) communicating with the outside of the valve body. The void 10 is a space surrounded by the wall surface 51w formed in the fourth block 51 and the sixth surface 526 of the fifth block 52. More specifically, as shown in FIGS. 4 and 9, a part of the fourth block 51 is removed to create a space 51s extending through the fourth block 51 in the stacking direction L, and the space 51s is surrounded by the wall surface 51w As shown in FIGS. 5 and 9, a space 52s is created in a part of the fifth block 52 by recessing the sixth surface 526 so as to correspond to the space 51s. As shown in FIG. 9, the void 10 is created by the wall surface 51w of the space 51s in the fourth block 51 and the recessed sixth surface 526 of the space 52s in the fifth block 52. Since the void 10 is thus open to the atmosphere, hydraulic oil can be drained from the void 10. Since the void 10 is present, oil pressure pulsations, if any pulsations occur for any reason, can be absorbed by the void 10. This restrains such pulsations from being transmitted to other oil passages, unlike in the case where the stacked blocks are welded together along their entire surfaces.

As shown in FIG. 5, for example, a closed space 52f is created in the sixth surface 526 in the case where the space is surrounded by the recess 526b on the same plane and does not have communication with the outside such as a drain oil passage or a breather hole. In this case, it is not preferable that the closed space 52f be hollow, because force in such a direction that the fourth block 51 and the fifth block 52 are separated from each other is generated due to expansion or compression of air. Accordingly, the closed space 52f is solid in the present embodiment, which restrains generation of force in such a direction that the fourth block 51 and the fifth block 52 are separated from each other due to expansion or compression of air. In the closed space 52f, not the entire fifth surface 515 and the entire sixth surface 526 are bonded together, and the fifth surface 515 and the sixth surface 526 are merely in contact with each other.

The plurality of large diameter grooves 515a and large diameter grooves 526a are disposed so as to overlap the pressure regulating portions 71 of the linear solenoid valves 70 as viewed in the stacking direction L. The plurality of small diameter grooves 515e and small diameter grooves 526c are disposed so as to overlap the solenoid portions 72 of the linear solenoid valves 70 as viewed in the stacking direction L. Accordingly, the oil passage mounting portion 50 is stacked on the solenoid mounting portion 40 in the stacking direction L, namely a direction crossing the direction of the central axis of the spool 70p, and has formed therein the plurality of oil passages 81, 82 including the large diameter oil passages 81 and the small diameter oil passages 82 having a smaller diameter than the large diameter oil passages 81. In the present embodiment, the stacking direction L is perpendicular to the direction of the central axis of the spool 70p.

In the present embodiment, the solenoid portions 72 of the linear solenoid valves 70 are disposed so as to overlap the small diameter oil passages 82 of the oil passage mounting portion 50 and so as not to overlap the large diameter oil passages 81 thereof as viewed in the stacking direction L. The pressure regulating portions 71 of the linear solenoid valves 70 are disposed so as to overlap the large diameter oil passages 81 of the oil passage mounting portion 50 as viewed in the stacking direction L. The solenoid portions of the solenoid valves 79 are disposed so as to overlap the large diameter oil passages 81 of the oil passage mounting portion 50 as viewed in the stacking direction L. However, since the solenoid portions of the solenoid valves 79 have a smaller diameter than the solenoid portions 72 of the linear solenoid valves 70, the solenoid portions of the solenoid valves 79 do not interfere with the large diameter oil passages 81 of the oil passage mounting portion 50. For example, the large diameter oil passages 81 are used to cause high flow rate hydraulic oil, such as a line pressure, a range pressure, or an oil pressure that controls a friction engagement element, to pass therethrough. For example, the small diameter oil passages 82 are used to cause low flow rate hydraulic oil, such as a signal pressure for the switch valve 66, to flow therethrough.

Next, as shown in FIGS. 2 to 9, the valve mounting portion 60 has three substantially plate-like synthetic resin blocks, namely a sixth block 61, a seventh block 62, and an eighth block 63, and is formed by stacking these three layers and joining the stacked layers by, e.g., injection molding. The valve mounting portion 60 is stacked on the opposite side of the oil passage mounting portion 50 from the solenoid mounting portion 40 in the stacking direction L and accommodates the switch valves 66. In the present embodiment, the seventh block 62 is disposed on the side of the fifth block 52 which fixes the second direction D2, and the seventh block 62 and the fifth block 52 are formed by a single member. However, the seventh block 62 and the fifth block 52 are not limited to a single member. The seventh block 62 and the fifth block 52 may be formed by separate members joined by injection molding, adhesion, welding, etc.

The sixth block 61 is the middle one of the three layers forming the valve mounting portion 60 and has a plurality of holes 64 extending inward from its one side end and the opposite other side end in a direction perpendicular to the stacking direction L. In the present embodiment, the sixth block 61 is formed with bottomed cylindrical metal sleeves 65 insert-molded therein by primary injection molding of the DSI method, and the insides of the sleeves 65 are the holes 64.

A switch valve 66, which is a spool valve, is mounted in each sleeve 65. A slidable spool 66p, a biasing spring 66s, which is a compression coil spring that presses the spool 66p in one direction, and a stopper 67 that allows the biasing spring 66s to press the spool 66p are accommodated in each sleeve 65, and these components form a switch valve 66. The stopper 67 is fixed near an opening portion of the sleeve 65 with a fastener 68. Each sleeve 65 has ports, which are multiple through holes, in its peripheral side surface. Each port is formed along substantially the entire circumference and is closed, except for its opening portion, by the synthetic resin forming the sixth block 61. For example, the switch valve 66 can switch between oil passages or regulate an oil pressure.

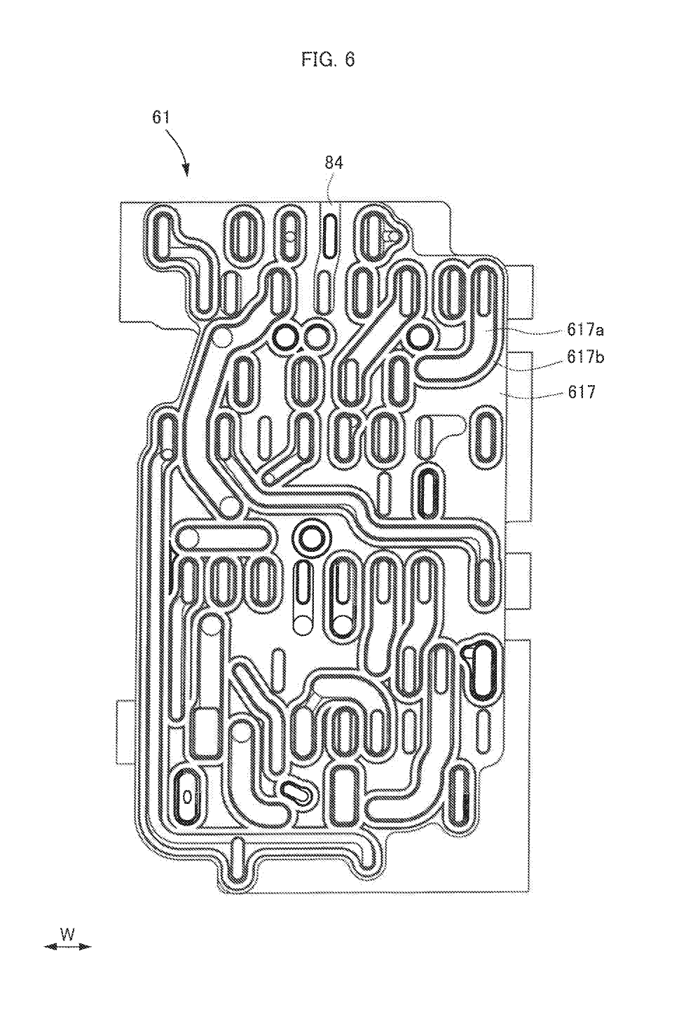

The sixth block (third layer) 61 has a seventh surface (fourth opposing surface) 617, a plurality of grooves (sixth grooves) 617a with a semicircular section, which are formed in the seventh surface 617, and a protrusion (sixth bonding portion/sixth bonding) 617b formed on the seventh surface 617 (see FIG. 6). The plurality of grooves 617a communicate with a part of the plurality of ports of the switch valves 66. The protrusion 617b is formed between adjacent ones of the grooves 617a on the seventh surface 617 and protrudes toward the seventh block 62. The sixth block 61 further has an eighth surface 618 located on the opposite side of the sixth block 61 from the seventh surface 617, a plurality of grooves 618a with a semicircular section, which are formed in the eighth surface 618, and a protrusion 618b formed on the eighth surface 618. The plurality of grooves 618a communicate with a part of the plurality of ports of the switch valves 66. The protrusion 618b is formed between adjacent ones of the grooves 618a on the eighth surface 618 and protrudes toward the eighth block 63. The sixth block 61 further has the plurality of holes 64 formed between the seventh surface 617 and the eighth surface 618 so as to extend along the seventh surface 617 and the eighth surface 618 and accommodating the switch valves 66.

The seventh block 62 is stacked on the opposite side of the sixth block 61 from the transmission case 32. The seventh block 62 has a ninth surface (third opposing surface) 629, a plurality of grooves (fifth grooves) 629a with a semicircular section, which are formed in the ninth surface 629, and a recess (fifth bonding portion/fifth bonding) 629b formed in the ninth surface 629. The plurality of grooves 629a are formed so as to face the plurality of grooves 617a. The seventh block 62 is stacked on the sixth block 61 in the stacking direction L with the ninth surface 629 facing the seventh surface 617 of the sixth block 61, so that the plurality of seventh grooves 617a and the plurality of grooves 629a form a plurality of oil passages (third oil passages) 83. The oil passages 81, 82 communicate with the oil passages 83 in a direction crossing, e.g., perpendicular to, opposing surfaces such as the seventh surface 617 and the ninth surface 629.

The recess 629b is recessed in the same direction as that in which the protrusion 617b on the seventh surface 617 protrudes, and the protrusion 617b is fitted in the recess 629b with clearance in the stacking direction L. In the present embodiment, the sixth block 61 and the seventh block 62 are stacked such that the protrusion 617b is fitted in the recess 629b between adjacent ones of the oil passages 80, and an injection molding material is injected as the sealing member S into the clearance between the protrusion 617b and the recess 629b, whereby the sixth block 61 and the seventh block 62 are joined by injection molding using the clearance as a cavity.

The eighth block 63 is stacked on the opposite side of the sixth block 61 from the seventh block 62 and is attached to the transmission case 32. The eighth block 63 has a tenth surface 630, a plurality of grooves 630a with a semicircular section, which are formed in the tenth surface 630, and a recess 630b formed in the tenth surface 630. The plurality of grooves 630a are formed so as to face the plurality of grooves 618a. The eighth block 63 is stacked on the sixth block 61 with the tenth surface 630 facing the eighth surface 618 of the sixth block 61, so that the plurality of grooves 630a and the plurality of grooves 618a form a plurality of oil passages 80.

The recess 630b is recessed in the same direction as that in which the protrusion 618b on the eighth surface 618 protrudes, and the protrusion 618b is fitted in the recess 630b with clearance in the stacking direction L. The sixth block 61 and the eighth block 63 are stacked such that the protrusion 618b is fitted in the recess 630b between adjacent ones of the oil passages 80, and are joined by injection molding using the clearance between the protrusion 618b and the recess 630b as a cavity.

In the present embodiment, as shown in FIG. 3, a drain oil passage 84 is formed, e.g., between the sixth block (first layer) 61 and the seventh block (second layer) 62. The sixth block 61 has a first drain groove 84a formed. in the seventh surface 617, and the seventh block 62 has a second drain groove 84b facing the first drain groove 84a and formed in the ninth surface 629. Since the ninth surface 629 is placed on, and bonded to, the seventh surface 617, the drain oil passage 84, which is formed by the first drain groove 84a and the second drain groove 84b, communicates with the outside of the sixth block 61 and the seventh block 62 and drains hydraulic oil to the outside of the sixth block 61 and the seventh block 62. No bonding portion, namely neither a protrusion nor a recess, is formed around the drain oil passage 84. That is, no bonding portion surrounds the drain oil passage 84. Oil that flows in the drain oil passage 84 has a relatively low pressure and is less likely to leak between the seventh surface 617 and the ninth surface 629 from the drain oil passage 84. Even if oil leaks between the seventh surface 617 and the ninth surface 629 from the drain oil passage 84, the influence of such leakage is small. Bonding portions can therefore be omitted far the drain oil passage 84. The number of places where the bonding portion should be formed is thus minimized. This simplifies the structure of the valve body and achieves reduction in size of the valve body. In this example, the drain oil passage 84 is shown only between the sixth block 61 and the seventh block 62. However, the drain oil passage 84 actually also communicates with other blocks and no bonding portion is formed around the drain oil passage 84 in other blocks, either.

For example, of the oil passages 80 communicating with a switch valve 66 in the valve mounting portion 60, a large diameter oil passage that causes high flow rate hydraulic oil to flow therethrough communicates with another switch valve 66 in the valve mounting portion 60, communicates with another switch valve 66 in the valve mounting portion 60 via the large diameter oil passages 81 of the oil passage mounting portion 50, or communicates with the linear solenoid valves 70 or the solenoid valves 79 in the solenoid mounting portion 40 via the large diameter oil passages 81 of the oil passage mounting portion 50. For example, of the oil passages 80 communicating with a switch valve 66 in the valve mounting portion 60, a small diameter oil passage that causes low flow rate hydraulic oil to flow therethrough communicates with another switch valve 66 in the valve mounting portion 60, communicates with another switch valve 66 in the valve mounting portion 60 via the small diameter oil passages 82 of the oil passage mounting portion 50, or communicates with the solenoid valves 79 in the solenoid mounting portion 40 via the small diameter oil passages 82 in the oil passage mounting portion 50. That is, at least a part of the oil passages 81, 82 of the oil passage mounting portion 50 allow the linear solenoid valves 70 in the solenoid mounting portion 40 to communicate with the switch valves 66 in the valve mounting portion 60.

In the above description, the protrusion 515b formed on the fifth surface 515 and the recess 526b formed in the sixth surface 526 are bonded together to surround and seal the oil passages 81, 82 located in both the fifth surface 515 and the sixth surface 526. However, the present disclosure is not limited to the protrusion 515b and the recess 526b. That is, the protrusions and the recesses in other surfaces can similarly be formed so as to surround adjacent ones of the oil passages 80, whereby the oil passages 80 can be sealed by bonding between the protrusion and the recess. In the present embodiment, the protrusion 411b and the recess 423b are bonded together to surround and seal the oil passages 80, the protrusion 412b and the recess 434b are bonded together to surround and seal the oil passages 80, the protrusion 617b and the recess 629b are bonded together to surround and seal the oil passages 80, and the protrusion 618b and the recess 630b are bonded together to surround and seal the oil passages 80.

In the present embodiment, the aforementioned valve body of the hydraulic control device 4 for the automatic transmission 3 is manufactured by the DSI method. Accordingly, when manufacturing the valve body of the hydraulic control device 4, each of the first to eighth blocks 41 to 63 is molded by injection molding, and opposing dies are moved relative to each other without removing the blocks from a mold. By this die slide operation, a part of the layers are stacked with a protrusion being fitted in a recess, and a synthetic resin is injected into a cavity to perform injection molding, whereby the stacked layers are joined. The die slide operation and the stacking operation are performed for all of the bonding surfaces of the first to eighth blocks 41 to 63, thereby forming the valve body. In the present embodiment, the sealing member S that joins the stacked blocks is an injection molding material. However, the present disclosure is not limited to this. For example, the sealing member S may be an adhesive. That is, the protrusion and the recess in each layer may be joined by adhesion. In this case, the valve body can be assembled at low cost.

Operation of the aforementioned hydraulic control device 4 for the automatic transmission 3 will be described with reference to FIGS. 1 to 9.

When the oil pump is driven to supply an oil pressure after starting of the internal combustion engine 2, a regulator valve and a modulator valve generate a line pressure and a modulator pressure. The line pressure and the modulator pressure thus generated are supplied to the linear solenoid valves 70 and the solenoid valves 79 through the oil passages 80 of the solenoid mounting portion 40. The linear solenoid valve 70 operates according to an electrical signal from the ECU 5 to generate and output a desired oil pressure based on the line pressure and the modulator pressure. The solenoid valve 79 operates according to an electrical signal from the ECU 5 to supply and cut off supply of an oil pressure based on the line pressure and the modulator pressure.

A part of the oil pressures supplied from the linear solenoid valves 70 and solenoid valves 79 are supplied to the automatic transmission 3 through the oil passage mounting portion 50 and the valve mounting portion 60. Another part of the oil pressures supplied from the linear solenoid valves 70 and the solenoid valves 79 are supplied to the switch valves 66 through the oil passage mounting portion 50. The positions of the spools 66p of the switch valves 66 are thus switched, or the ports thereof are allowed to communicate with each other or communication between the ports is cut off, so that the oil pressures are supplied to the automatic transmission 3. The oil pressures are thus supplied to the automatic transmission 3, whereby the clutches, the brakes, etc. of the automatic transmission 3 are engaged or disengaged to establish a desired shift speed, or each part of the automatic transmission 3 is lubricated.

As described above, according to the hydraulic control device 4 for the automatic transmission 3 of the present embodiment, the protrusion 515b and the recess 526b are fitted and bonded together to surround and seal the oil passages 81, 82 located in both the fifth surface 515 and the sixth surface 526. In this case, the protrusion 515b and the recess 526b which serve to bond the fourth block 51 and the fifth block 52 together also serve to seal the oil passages 81, 82. Accordingly, an increase in size of the valve body is restrained while providing sealability required for the oil passages 81, 82, as compared to the case where bonding portions and sealing portions are provided separately.

According to the hydraulic control device 4 for the automatic transmission 3 of the present embodiment, the first bonding portion is the protrusion 515b protruding toward the recess 526b, and the second bonding portion is the recess 526b recessed in the same direction as that in which the protrusion 515b protrudes and having the protrusion 515b fitted therein. Accordingly, as compared to the case where the protrusion 515b and the recess 526b are not formed and the fifth surface 515 and the sixth surface 526 are directly bonded together, bonding strength in the bonding portions is improved, and the interval between the oil passages 81, 82 which is required to achieve desired strength can therefore be reduced. Since the protrusion 515b is fitted in the recess 526b, a partition wall that restrains oil leakage is formed in a direction along the fifth surface 515 and the sixth surface 526 as viewed from the oil passages 81, 82. Accordingly, an increase in size of the valve body is restrained while providing sealability required for the oil passages 81, 82, as compared to the case where the protrusion 515b and the recess 526b are not formed.

According to the hydraulic control device 4 for the automatic transmission 3 of the present embodiment, the height of the protrusion 515b is smaller than the depth of the recess 526b, and the space between the distal end face of the protrusion 515b and the bottom surface of the recess 526b is filled with the sealing member S, so that the protrusion 515h and the recess 526b are bonded together by the sealing member S. Accordingly, as compared to the case where the protrusion 515b and the recess 526b are formed so that there will be no clearance therebetween, the sealing member S can be effectively injected into the entire region, and sealability required for the oil passages 81, 82 is provided.

According to the hydraulic control device 4 for the automatic transmission 3 of the present embodiment, the sealing member S is an injection molding material and the protrusion 515b and the recess 526b are bonded together by injection molding. The DSI method can therefore be used to manufacture the valve body, and satisfactory productivity is realized.

According to the hydraulic control device 4 for the automatic transmission 3 of the present embodiment, the solenoid portions 72 of the linear solenoid valves 70 provided in the solenoid mounting portion 40 are disposed so as to overlap the small diameter oil passages 82 of the oil passage mounting portion 50 as viewed in the stacking direction L. Accordingly, as compared to the case where the solenoid portions 72 are disposed so as to overlap the large diameter oil passages 81 having a larger diameter than the small diameter oil passages 82, the thickness in the stacking direction L can be reduced, and an increase in size of the valve body of the hydraulic control device 4 is restrained.

According to the hydraulic control device 4 for the automatic transmission 3 of the present embodiment, the void 10 is created between two pairs of protrusions 515b and recesses 526b. Since the void 10 is open to the atmosphere, hydraulic oil can be drained from the void 10. Since the void 10 is created, oil pressure pulsations, if such pulsations occur for any reason, can be absorbed by the void 10. This restrains pulsations from being transmitted to other oil passages, unlike in the case where the stacked blocks are welded together along their entire surfaces.

The aforementioned hydraulic control device 4 for the automatic transmission 3 of the present embodiment is described with respect to the case where the height of the protrusion 515b is smaller than the depth of the recess 526b. However, the present disclosure is not limited to this, and the height of the protrusion 515b may be the same as the depth of the recess 526b. In this case, the protrusion 515b and the recess 526b are bonded together by adhesion, pressure bonding, etc.

The automatic transmission 3 of the present embodiment is described with respect to the case where all of the first to eighth blocks 41 to 63 are made of a synthetic resin. However, the present disclosure is not limited to this. At least a part of the layers may be made of a metal such as, e.g., aluminum die cast.

### Second Embodiment

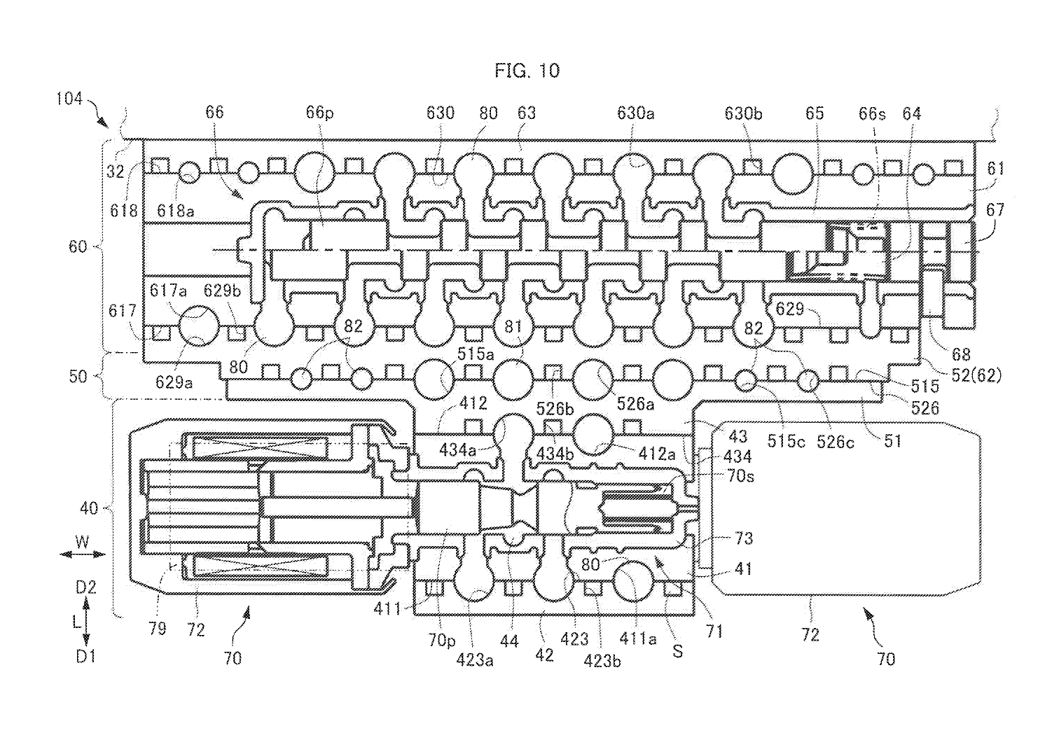

A second embodiment will be described in detail with reference to FIG. 10. For example, in a hydraulic control device 104 of the present embodiment, a first bonding portion of a fifth surface 515 is a flat surface, and a second bonding portion of a sixth surface 526 is a recess 526b. That is, at least one of the first bonding portion and the second bonding portion is a recess, and the recess 526b is filled with a sealing member S, so that the fifth surface 515 and the recess 526b are bonded together by the sealing member S. Similarly, a bonding portion of a first surface 414 is a flat surface, a bonding portion of a third surface 423 is a recess 423b, a bonding portion of a second surface 412 is a flat surface, a bonding portion of a fourth surface 434 is a recess 434b, a bonding portion of a seventh surface 617 is a flat surface, a bonding portion of a ninth surface 629 is a recess 629b, a bonding portion of an eighth surface 618 is a flat surface, and a bonding portion of a tenth surface 630 is a recess 630b. Since the configuration of the second embodiment is otherwise similar to that of the first embodiment, detailed description thereof will be omitted.

In the present embodiment as well, the space between the fifth surface 515 and the bottom surface of the recess 526b is filled with the sealing member S, so that the fifth surface 515 and the recess 526b are bonded together by the sealing member S. Moreover, the sealing member S is an injection molding material, and the fifth surface 515 and the recess 526b are bonded together by injection molding. The sealing member S is not limited to the injection molding material and may be an adhesive etc.

In the hydraulic control device 104 for the automatic transmission 3 of the present embodiment as well, the fifth surface 515 and the recess 526b are bonded together to surround and seal oil passages 81, 82 located in both the fifth surface 515 and the sixth surface 526. In this case, the fifth surface 515 and the recess 526b which serve to bond a fourth block 51 and a fifth block 52 together also serve to seal the oil passages 81, 82. Accordingly, an increase in size of a valve body is restrained while providing sealability required for the oil passages 81, 82, as compared to the case where bonding portions and sealing portions are provided separately.

In the hydraulic control device 104 for the automatic transmission 3 of the present embodiment, the first bonding portion is a flat surface, and the second bonding portion is the recess 526b. Accordingly, as compared to the case where the recess 526b is not formed and the fifth surface 515 and the sixth surface 526 are directly bonded together, bonding strength in the bonding portions is improved, and the interval between the oil passages 81, 82 which is required to achieve desired strength can therefore be reduced. An increase in size of the valve body is therefore restrained while providing sealability required for the oil passages 81, 82, as compared to the case where the recess 526b is not formed.

For example, in the aforementioned hydraulic control device 104 for the automatic transmission 3 of the present embodiment, the first bonding portion of the fifth surface 515 is a flat surface, the second bonding portion of the sixth surface 526 is the recess 526b. However, the present disclosure is not limited to this. For example, the first bonding portion of the fifth surface 515 may be a recess and the second bonding portion of the sixth surface 526 may be a flat surface. Alternatively, both the first bonding portion of the fifth surface 515 and the second bonding portion of the sixth surface 526 may be recesses.

The present embodiment includes at least the following configuration. A hydraulic control device (4) for an automatic transmission (3) of the present embodiment includes: a first layer (51) having a first opposing surface (515), a first groove (515a, 515c) formed in the first opposing surface (515), and a first bonding portion (515b) formed on the first opposing surface (515) and surrounding the first groove (515a, 515c); and a second layer (52) having a second opposing surface (526) facing the first opposing surface (515), a second groove (526a, 526c) facing the first groove (515a, 515c) and formed in the second opposing surface (526), and a second bonding portion (526b) facing the first bonding portion (515b), surrounding the second groove (526a, 526c), and bonded to the first bonding portion (515b), the second opposing surface (526) being placed on, and bonded to, the first opposing surface (515), so that the first groove (515a, 515c) and the second groove (526a, 526c) form a first oil passage (81, 82). The first bonding portion (515b) is a protrusion (515b) protruding toward the second bonding portion (526b), the second bonding portion (526b) is a recess (526b) having the protrusion (515b) fitted therein, and the first bonding portion (515b) and the second bonding portion (526b) are bonded together to surround and seal the first oil passage (81, 82) located in both the first opposing surface (515) and the second opposing surface (526). According to this configuration, the first bonding portion (515b), which is a protrusion, and the second bonding portion (526b), which is a recess, are fitted and bonded together to surround and seal the first oil passage (81, 82) located in both the first opposing surface (515) and the second opposing surface (526). In this case, the first bonding portion (515b) and the second bonding portion (526b) which serve to bond the fourth layer (51) and the second layer (52) together also serve to seal the first oil passage (81, 82). Accordingly, an increase in size of a valve body is restrained while providing sealability required for the first oil passage (81, 82), as compared to the case where bonding portions and sealing portions are provided separately.

Moreover, as compared to the case where the protrusion and the recess are not formed and the first opposing surface (515) and the second opposing surface (526) are directly bonded together, bonding strength in the bonding portions is improved, and the interval between the first oil passages (81, 82) which is required to achieve desired strength can therefore be reduced. Since the protrusion (515b) is fitted in the recess (526b), a partition wall that restrains oil leakage is formed in a direction along the first opposing surface (515) and the second opposing surface (526) as viewed from the first oil passage (81, 82). Accordingly, an increase in size of the valve body is restrained while providing sealability required for the first oil passage (81, 82), as compared to the case where the protrusion and the recess are not formed.

In the hydraulic control device (4) for the vehicle drive device (3) of the present embodiment, the height of the protrusion (515b) is smaller than the depth of the recess (526b), and a space between a distal. end face of the protrusion (515b) and a bottom surface of the recess (526b) is filled with a sealing member (S), so that the protrusion (515b) and the recess (526b) are bonded together by the sealing member (S). According to this configuration, as compared to the ease where the protrusion and the recess are formed so that there will be no clearance therebetween, the sealing member (S) can be effectively injected into the entire region, and sealability required for the first oil passage (81, 82) is provided.

In the hydraulic control device (4) for the vehicle drive device (3) of the present embodiment, the first layer (51) has a third groove (515a, 515c) formed in the first opposing surface (515) so as to be adjacent to the first groove (515a, 515c), and a third bonding portion (515b) surrounding the third groove (515a, 515c), the second layer (52) has a fourth groove (526a, 526c) formed in the second opposing surface (526) so as to face the third groove (515a, 515c), and a fourth. bonding portion (526b) surrounding the fourth groove (526a, 526c), the third groove (515a, 515c) and the fourth groove (526a, 526c) form a. second oil passage (81, 82) adjacent to the first oil passage (81, 82), and a part of the first and second bonding portions (515b, 526b) bonded together and the third and fourth bonding portions (515b, 526b) bonded together is provided between the first oil passage (81, 82) and the second oil passage (81, 82) as a single common pair of bonding portions bonded together. According to this configuration, since the first bonding portion (515b) and the third bonding portion (515b) are provided as a common bonding portion, and the second bonding portion (526b) and the fourth bonding portion (526b) are provided as a common bonding portion, the number of places where the bonding portion should be formed is minimized. This simplifies the structure of the valve body and achieves reduction in size of the valve body.

In the hydraulic control device (4) for the vehicle drive device (3) of the present embodiment, the third bonding portion (515b) is a protrusion (515b) protruding toward the fourth bonding portion (526b), the fourth bonding portion (526b) is a recess (526b) having the protrusion (515b) fitted therein, and the common pair of bonding portions is provided in a region where an interval between a first-oil-passage-side end of the second bonding portion (526b) located on the second oil passage (81, 82) side of the first oil passage (81, 82) and a second-oil-passage-side end of the fourth bonding portion (526b) located on the first oil passage (81, 82) side of the second oil passage (81, 82) is smaller than a sum of a width of the first and second bonding portions (515b, 526b) bonded together and a width of the third and fourth bonding portions (515b, 526b) bonded together. According to this configuration, both the second bonding portion (526b) and the fourth bonding portion (526b) are recesses. Accordingly, the number of places where the bonding portion should be formed is minimized by providing the first bonding portion (515b) and the third bonding portion (515b) as a common bonding portion and providing the second bonding portion (526b) and the fourth bonding portion (526b) as a common bonding portion based on the interval between outer walls of adjacent ones of the recesses. This simplifies the structure of the valve body and achieves reduction in size of the valve body.

In the hydraulic control device (4) for the vehicle drive device (3) of the present embodiment, the first layer (51) has a third groove (515a, 515c) formed in the first opposing surface (515) so as to be adjacent to the first groove (515a, 515c), and a third bonding portion (515b) surrounding the third groove (515a, 515c), the second layer (52) has a fourth groove (526a, 526c) formed in the second opposing surface (526) so as to face the third groove (515a, 515c), and a fourth bonding portion (526b) surrounding the fourth groove (526a, 526c), the third groove (515a, 515c) and the fourth groove (526a, 526c) form a second oil passage (81, 82) adjacent to the first oil passage (81, 82), the third bonding portion (515b) is a protrusion (515b) protruding toward the fourth bonding portion (526b), the fourth bonding portion (526b) is a recess (526b) having the protrusion (515b) fitted therein, and the first and second bonding portions (515b, 526b) bonded together and the third and fourth bonding portions (515b, 526b) bonded together are provided independently in a region where an interval between a first-oil-passage-side end of the second bonding portion (526b) located on the second oil passage (81, 82) side of the first oil passage (81, 82) and a second-oil-passage-side end of the fourth bonding portion (526b) located on the first oil passage (81, 82) side of the second oil passage (81, 82) is equal to or larger than a sum of a width of the first and second bonding portions (515b, 526b) bonded together and a width of the third and fourth bonding portions (515b, 526b) bonded together, and a void (10) is created in the second opposing surface (526) in at least a part of a region between the first and second bonding portions (515b, 526b) bonded together and the third and fourth bonding portions (515b, 526b) bonded together, the void (10) being surrounded by a wall surface (51w) that is formed in an outer peripheral side surface of the first layer (51) having, in at least a part of the first layer (51), a communication portion (52e) communicating with outside of the hydraulic control device (4). According to this configuration, since the void (10) is open to the atmosphere via the communication portion (52e), hydraulic oil can be drained from the void (10). Since the void (10) is present, oil pressure pulsations, if any pulsations occur for any reason, can be absorbed by the void (10). This restrains such pulsations from being transmitted to other oil passages, unlike in the case where the stacked blocks are welded together along their entire surfaces.

In the hydraulic control device (4) for the vehicle drive device (3) of the present embodiment, the first layer (51) has a third groove (515a, 515c) formed in the first opposing surface (515) so as to be adjacent to the first groove (515a, 515c), and a third bonding portion (515b) surrounding the third groove (515a, 515c), the second layer (52) has a fourth groove (526a, 526c) formed in the second opposing surface (526) so as to face the third groove (515a, 515c), and a fourth bonding portion (526b) surrounding the fourth groove (526a, 526c), the third groove (515a, 515c) and the fourth groove (526a, 526c) form a second oil passage (81, 82) adjacent to the first oil passage (81, 82), the third bonding portion (515b) is a protrusion (515b) protruding toward the fourth bonding portion (526b), the fourth bonding portion (526b) is a recess (526b) having the protrusion (515b) fitted therein, and the first and second bonding portions (515b, 526b) bonded together and the third and fourth bonding portions (515b, 526b) bonded together are provided independently in a region where an interval between a first-oil-passage-side end of the second bonding portion (526b) located on the second oil passage (81, 82) side of the first oil passage (81, 82) and a second-oil-passage-side end of the fourth bonding portion (526b) located on the first oil passage (81, 82) side of the second oil passage (81, 82) is equal to or larger than a sum of a width of the first and second bonding portions (515b, 526b) bonded together and a width of the third and fourth bonding portions (515b, 526b) bonded together, a space between the first and second bonding portions (515b, 526b) bonded together and the third and fourth bonding portions (515b, 526b) bonded together is a closed space (52f), and the closed space (52f) is solid. For example, a closed space is created in the second opposing surface (526) in the case where the space is surrounded by the bonding portion (526b) on the same plane and does not have communication with the outside such as a drain oil passage or a breather hole. In this case, it is not preferable that the closed space be hollow, because force in such a direction that the first layer (51) and the second layer (52) are separated from each other is generated due to expansion or compression of air. Accordingly, in the present embodiment, the closed space (52f) is solid, which restrains generation of the force in such a direction that the first layer (51) and the second layer (52) are separated from each other due to expansion or compression of air.

In the hydraulic control device (4) for the vehicle drive device (3) of the present embodiment, the first layer (61) has a first drain groove (84a) formed in the first opposing surface (617), the second layer (62) has a second drain groove (84b) facing the first drain groove (84a) and formed in the second opposing surface (629), the second opposing surface (617) is placed on, and bonded to, the first opposing surface (629), so that the first drain groove (84a) and the second drain groove (84b) form a drain oil passage (84) that communicates with outside of the first layer (51) and the second layer (52) and drains hydraulic oil to the outside of the first layer (51) and the second layer (52), and the drain oil passage (84) is surrounded by a bonding surface formed by placing the first opposing surface (617) on the second opposing surface (629). According to this configuration, oil that flows in the drain oil passage (84) has a relatively low pressure and is less likely to leak to the surrounding area from the drain oil passage (84). Even if oil leaks to the surrounding area from the drain oil passage (84), the influence of such leakage is small. The number of places where the first bonding portion (617b) and the second bonding portion (629b) should be formed is therefore minimized. This simplifies the structure of the valve body and achieves reduction in size of the valve body.

The hydraulic control device (4) for the vehicle drive device (3) of the present embodiment further includes a third layer (61) stacked on an opposite side of the second layer (52, 62) from the first layer (51). The second layer (52, 62) has a third opposing surface (629) formed on an opposite side of the second layer (52, 62) from the second opposing surface (526), a fifth groove (629a) formed in the third opposing surface (629), and a fifth bonding portion (629b) formed in the third opposing surface (629) and surrounding the fifth groove (629a), the third layer (61) has a fourth opposing surface (617) facing the third opposing surface (629), a sixth groove (617a) formed in the fourth opposing surface (617) and facing the fifth groove (629a), and a sixth bonding portion (617b) formed on the fourth opposing surface (617) and surrounding the sixth groove (617a), the fourth opposing surface (617) being placed on, and bonded to, the third opposing surface (629), so that the fifth groove (629a) and the sixth groove (617a) form a third oil passage (83), the second layer (52) has a communication oil passage (91, 92) that extends in a direction (L) in which the first layer (51), the second layer (52), and the third layer (61) are stacked and that allows the first oil passage (81, 82) and the third oil passage (83) to communicate with each other, and the first oil passage (81, 82) and the third oil passage (83) communicate with each other via the communication oil passage in a direction perpendicular to each opposing surface (515, 526, 629, 617). According to this configuration, the first oil passage (81, 82) communicates with the third oil passage (83) via the communication oil passage (91, 92). This allows hydraulic oil to flow between the first layer (51) and the second layer (52) and in other portions.

In the hydraulic control device (4) for the vehicle drive device (3) of the present embodiment, the sealing member (S) is an injection molding material, and the first bonding portion (515b) and the second bonding portion (526b) are bonded together by injection molding. According to this configuration, the DSI method can be used to manufacture the valve body, and satisfactory productivity is realized.

In the hydraulic control device (4) for the vehicle drive device (3) of the present embodiment, the first oil passage (81, 82) communicates two of a hydraulic servo (33) capable of engaging and disengaging a friction engagement element (C1) by supplying and cutting off supply of an oil pressure, a linear solenoid valve (70) capable of supplying an oil pressure to the hydraulic servo (33), and an input port of a switch valve (66) capable of switching between oil passages or regulating an oil pressure. According to this configuration, an automatic transmission (3) capable of establishing a plurality of shift speeds according to combinations of a plurality of friction engagement elements (C1) that are engaged simultaneously can be used as the vehicle drive device (3), and reduction in size of the valve body is achieved for the automatic transmission (3).

### INDUSTRIAL APPLICABILITY

The hydraulic control device for the automatic transmission according to the present disclosure is preferably used in automatic transmissions that can be mounted on, e.g., vehicles etc. and that particularly engage and disengage engagement elements etc. by supplying and cutting off supply of oil pressures.

1-10. (canceled)

11. A hydraulic control device for a vehicle drive device, comprising:
a first layer having a first opposing surface, a first groove formed in the first opposing surface, and a first bonding formed on the first opposing surface and surrounding the first groove; and
a second layer having a second opposing surface facing the first opposing surface, a second groove facing the first groove and formed in the second opposing surface, and a second bonding facing the first bonding, surrounding the second groove, and bonded to the first bonding, the second opposing surface being placed on, and bonded to, the first opposing surface, so that the first groove and the second groove form a first oil passage, wherein
the first bonding is a protrusion protruding toward the second bonding,
the second bonding is a recess having the protrusion fitted therein, and
the first bonding and the second bonding are bonded together to surround and seal the first oil passage located in both the first opposing surface and the second opposing surface.

12. The hydraulic control device for the vehicle drive device according to claim 11, wherein
a height of the protrusion is smaller than a depth of the recess, and a space between a distal end face of the protrusion and a bottom surface of the recess is filled with a sealing member, so that the protrusion and the recess are bonded together by the sealing member.

13. The hydraulic control device for the vehicle drive device according to claim 12, wherein
the first layer has a third groove formed in the first opposing surface so as to be adjacent to the first groove, and a third bonding surrounding the third groove,
the second layer has a fourth groove formed in the second opposing surface so as to face the third groove, and a fourth bonding surrounding the fourth groove,
the third groove and the fourth groove form a second oil passage adjacent to the first oil passage, and
a part of the first and second bondings bonded together and the third and fourth bondings bonded together is provided between the first oil passage and the second oil passage as a single common pair of bondings bonded together.

14. The hydraulic control device for the vehicle drive device according to claim 13, wherein
the third bonding is a protrusion protruding toward the fourth bonding,
the fourth bonding is a recess having the protrusion fitted therein, and
the common pair of bondings is provided in a region where an interval between a first-oil-passage-side end of the second bonding located on the second oil passage side of the first oil passage and a second-oil-passage-side end of the fourth bonding located on the first oil passage side of the second oil passage is smaller than a sum of a width of the first and second bondings bonded together and a width of the third and fourth bondings bonded together.

15. The hydraulic control device for the vehicle drive device according to claim 14, wherein
the first layer has a first drain groove formed in the first opposing surface,
the second layer has a second drain groove facing the first drain groove and formed in the second opposing surface,
the second opposing surface is placed on, and bonded to, the first opposing surface, so that the first drain groove and the second drain groove form a drain oil passage that communicates with outside of the first layer and the second layer and drains hydraulic oil to the outside of the first layer and the second layer, and
the drain oil passage is surrounded by a bonding surface formed by placing the first opposing surface on the second opposing surface.

16. The hydraulic control device for the vehicle drive device according to claim 15, further comprising:
a third layer stacked on an opposite side of the second layer from the first layer, wherein
the second layer has a third opposing surface formed on an opposite side of the second layer from the second opposing surface, a fifth groove formed in the third opposing surface, and a fifth bonding formed on the third opposing surface and surrounding the fifth groove,
the third layer has a fourth opposing surface facing the third opposing surface, a sixth groove formed in the fourth opposing surface and facing the fifth groove, and a sixth bonding formed on the fourth opposing surface and surrounding the sixth groove, the fourth opposing surface being placed on, and bonded to, the third opposing surface, so that the fifth groove and the sixth groove form a third ail passage,
the second layer has a communication oil passage that extends in a direction in which the first layer, the second layer, and the third layer are stacked and that allows the first oil passage and the third oil passage to communicate with each other, and
the first oil passage and the third oil passage communicate with each other via the communication oil passage in a direction perpendicular to each opposing surface.

17. The hydraulic control device for the vehicle drive device according to claim 16, wherein
the first oil passage communicates two of a hydraulic servo capable of engaging and disengaging a friction engagement element by supplying and cutting off supply of an oil pressure, a linear solenoid valve capable of supplying an oil pressure to the hydraulic servo, and an input port of a switch valve capable of switching between oil passages or regulating an oil pressure.

18. The hydraulic control device for the vehicle drive device according to claim 12, wherein
the first layer has a third groove formed in the first opposing surface so as to be adjacent to the first groove, and a third bonding surrounding the third groove,
the second layer has a fourth groove formed in the second opposing surface so as to face the third groove, and a fourth bonding surrounding the fourth groove,
the third groove and the fourth groove form a second oil passage adjacent to the first oil passage,
the third bonding is a protrusion protruding toward the fourth bonding,
the fourth bonding is a recess having the protrusion fitted therein, and
the first and second bondings bonded together and the third and fourth bondings bonded together are provided independently in a region where an interval between a first-oil-passage-side end of the second bonding located on the second oil passage side of the first oil passage and a second-oil-passage-side end of the fourth bonding located on the first oil passage side of the second oil passage is equal to or larger than a sum of a width of the first and second bondings bonded together and a width of the third and fourth bondings bonded together, and a void is created in the second opposing surface in at least a part of a region between the first and second bondings bonded together and the third and fourth bondings bonded together, the void being surrounded by a wall surface that is formed in an outer peripheral side surface of the first layer having, in at least a part of the first layer, a communicator communicating with outside of the hydraulic control device.

19. The hydraulic control device for the vehicle drive device according to claim 12, wherein
the first layer has a third groove formed in the first opposing surface so as to be adjacent to the first groove, and a third bonding surrounding the third groove,
the second layer has a fourth groove formed in the second opposing surface so as to face the third groove, and a fourth bonding surrounding the fourth groove,
the third groove and the fourth groove form a second oil passage adjacent to the first oil passage,
the third bonding is a protrusion protruding toward the fourth bonding,
the fourth bonding is a recess having the protrusion fitted therein, and
the first and second bondings bonded together and the third and fourth bondings bonded together are provided independently in a region where an interval between a first-oil-passage-side end of the second bonding located on the second oil passage side of the first oil passage and a second-oil-passage-side end of the fourth bonding located on the first oil passage side of the second oil passage is equal to or larger than a sum of a width of the first and second bondings bonded together and a width of the third and fourth bondings bonded together, a space between the first and second bondings bonded together and the third and fourth bondings bonded together is a closed space, and the closed space is solid.

20. The hydraulic control device for the vehicle drive device according to claim 12, wherein
the first layer has a first drain groove formed in the first opposing surface,
the second layer has a second drain groove facing the first drain groove and formed in the second opposing surface,
the second opposing surface is placed on, and bonded to, the first opposing surface, so that the first drain groove and the second drain groove form a drain oil passage that communicates with outside of the first layer and the second layer and drains hydraulic oil to the outside of the first layer and the second layer, and
the drain oil passage is surrounded by a bonding surface formed by placing the first opposing surface on the second opposing surface.

21. The hydraulic control device for the vehicle drive device according to claim 12, further comprising:
a third layer stacked on an opposite side of the second layer from the first layer, wherein
the second layer has a third opposing surface formed on an opposite side of the second layer from the second opposing surface, a fifth groove formed in the third opposing surface, and a fifth bonding formed on the third opposing surface and surrounding the fifth groove,
the third layer has a fourth opposing surface facing the third opposing surface, a sixth groove formed in the fourth opposing surface and facing the fifth groove, and a sixth bonding formed on the fourth opposing surface and surrounding the sixth groove, the fourth opposing surface being placed on, and bonded to, the third opposing surface, so that the fifth groove and the sixth groove form a third oil passage,
the second layer has a communication oil passage that extends in a direction in which the first layer, the second layer, and the third layer are stacked and that allows the first oil passage and the third oil passage to communicate with each other, and
the first oil passage and the third oil passage communicate with each other via the communication oil passage in a direction perpendicular to each opposing surface.

22. The hydraulic control device for the vehicle drive device according to claim 12, wherein
the sealing member is an injection molding material, and the first bonding and the second bonding are bonded together by injection molding.

23. The hydraulic control device for the vehicle drive device according to claim 12, wherein
the first oil passage communicates two of a hydraulic servo capable of engaging and disengaging a friction engagement element by supplying and cutting off supply of an oil pressure, a linear solenoid valve capable of supplying an oil pressure to the hydraulic servo, and an input port of a switch valve capable of switching between oil passages or regulating an oil pressure.

24. The hydraulic control device for the vehicle drive device according to claim 11, wherein
the first layer has a third groove formed in the first opposing surface so as to be adjacent to the first groove, and a third bonding surrounding the third groove,
the second layer has a fourth groove formed in the second opposing surface so as to face the third groove, and a fourth bonding surrounding the fourth groove,
the third groove and the fourth groove form a second oil passage adjacent to the first oil passage, and
a part of the first and second bondings bonded together and the third and fourth bondings bonded together is provided between the first oil passage and the second oil passage as a single common pair of bondings bonded together.

25. The hydraulic control device for the vehicle drive device according to claim 24, wherein
the third bonding is a protrusion protruding toward the fourth bonding,
the fourth bonding is a recess having the protrusion fitted therein, and
the common pair of bondings is provided in a region where an interval between a first-oil-passage-side end of the second bonding located on the second oil passage side of the first oil passage and a second-oil-passage-side end of the fourth bonding located on the first oil passage side of the second oil passage is smaller than a sum of a width of the first and second bondings bonded together and a width of the third and fourth bondings bonded together.

26. The hydraulic control device for the vehicle drive device according to claim 11, wherein
the first layer has a third groove formed in the first opposing surface so as to be adjacent to the first groove, and a third bonding surrounding the third groove,
the second layer has a fourth groove formed in the second opposing surface so as to face the third groove, and a fourth bonding surrounding the fourth groove,
the third groove and the fourth groove form a second oil passage adjacent to the first oil passage,
the third bonding is a protrusion protruding toward the fourth bonding,
the fourth bonding is a recess having the protrusion fitted therein, and
the first and second bondings bonded together and the third and fourth bondings bonded together are provided independently in a region where an interval between a first-oil-passage-side end of the second bonding located on the second oil passage side of the first oil passage and a second-oil-passage-side end of the fourth bonding located on the first oil passage side of the second oil passage is equal to or larger than a sum of a width of the first and second bondings bonded together and a width of the third and fourth bondings bonded together, and a void is created in the second opposing surface in at least a part of a region between the first and second bondings bonded together and the third and fourth bondings bonded together, the void being surrounded by a wall surface that is formed in an outer peripheral side surface of the first layer having, in at least a part of the first layer, a communicator communicating with outside of the hydraulic control device.

27. The hydraulic control device for the vehicle drive device according to claim 11, wherein
the first layer has a third groove formed in the first opposing surface so as to be adjacent to the first groove, and a third bonding surrounding the third groove,
the second layer has a fourth groove formed in the second opposing surface so as to face the third groove, and a fourth bonding surrounding the fourth groove,
the third groove and the fourth groove form a second oil passage adjacent to the first oil passage,
the third bonding is a protrusion protruding toward the fourth bonding,
the fourth bonding is a recess having the protrusion fitted therein, and
the first and second bondings bonded together and the third and fourth bondings bonded together are provided independently in a region where an interval between a first-oil-passage-side end of the second located on the second oil passage side of the first oil passage and a second-oil-passage-side end of the fourth bonding located on the first oil passage side of the second oil passage is equal to or larger than a sum of a width of the first and second bondings bonded together and a width of the third and fourth bondings bonded together, a space between the first and second bondings bonded together and the third and fourth bondings bonded together is a closed space, and the closed space is solid.

28. The hydraulic control device for the vehicle drive device according to claim 11, wherein
the first layer has a first drain groove formed in the first opposing surface,
the second layer has a second drain groove facing the first drain groove and formed in the second opposing surface,
the second opposing surface is placed on, and bonded to, the first opposing surface, so that the first drain groove and the second drain groove form a drain oil passage that communicates with outside of the first layer and the second layer and drains hydraulic oil to the outside of the first layer and the second layer, and
the drain oil passage is surrounded by a bonding surface formed by placing the first opposing surface on the second opposing surface.

29. The hydraulic control device for the vehicle drive device according to claim 11, further comprising:
a third layer stacked on an opposite side of the second layer from the first layer, wherein
the second layer has a third opposing surface formed on an opposite side of the second layer from the second opposing surface, a fifth groove formed in the third opposing surface, and a fifth bonding formed on the third opposing surface and surrounding the fifth groove,
the third layer has a fourth opposing surface facing the third opposing surface, a sixth groove formed in the fourth opposing surface and facing the fifth groove, and a sixth bonding formed on the fourth opposing surface and surrounding the sixth groove, the fourth opposing surface being placed on, and bonded to, the third opposing surface, so that the fifth groove and the sixth groove form a third oil passage,
the second layer has a communication oil passage that extends in a direction in which the first layer, the second layer, and the third layer are stacked and that allows the first oil passage and the third oil passage to communicate with each other, and
the first oil passage and the third oil passage communicate with each other via the communication oil passage in a direction perpendicular to each opposing surface.

30. The hydraulic control device for the vehicle drive device according to claim 11, wherein
the first oil passage communicates two of a hydraulic servo capable of engaging and disengaging a friction engagement element by supplying and cutting off supply of an oil pressure, a linear solenoid valve capable of supplying an oil pressure to the hydraulic servo, and an input port of a switch valve capable of switching between oil passages or regulating an oil pressure.
